(19) United States
(12) Patent Application Publication
(10) Pub. No.: US 2015/0118947 A1
(43) Pub. Date: Apr. 30, 2015

(54) VEHICULAR COLD-AIR SHIELDING STRUCTURE

(71) Applicant: HONDA MOTOR CO., LTD., Tokyo (JP)

(72) Inventors: Choji Sakuma, Wako-shi (JP); Yoshiyuki Takeuchi, Wako-shi (JP); Satoshi Kobayashi, Wako-shi (JP); Yoshinori Ishimoto, Wako-shi (JP); Ryosuke Nakashima, Wako-shi (JP)

(73) Assignee: HONDA MOTOR CO., LTD., Tokyo (JP)

(21) Appl. No.: 14/521,539

(22) Filed: Oct. 23, 2014

(30) Foreign Application Priority Data
Oct. 28, 2013 (JP) 2013-222903

(51) Int. Cl. B60N 2/56; B60H 1/24

(52) U.S. Cl. CPC B60N 2/5628; B60H 1/24
USPC 454/120

(57) ABSTRACT

A vehicular cold-air shielding structure that is provided on a floor of a vehicle includes a front seat that is slidable in the front-rear direction of the vehicle and a shielding member that is disposed under the front seat and that is provided so as to extend in the width direction of the vehicle. The shielding member has a flexibility that allows the shielding member to follow the sliding movement of the front seat.

### CROSS REFERENCES TO RELATED APPLICATIONS

The present application claims priority under 35 U.S.C. §119 to Japanese Patent Application No. 2013-222903, filed Oct. 28, 2013, entitled “Vehicular Cold-air Shielding Structure.” The contents of this application are incorporated herein by reference in their entirety.

### TECHNICAL FIELD

The present disclosure relates to a vehicular cold-air shielding structure.

### BACKGROUND

For example, Japanese Unexamined Utility Model Publication No. H05-72522 discloses a vehicular cold-air shielding structure that is provided with a board that is capable of shielding an upper portion and side portions of a front seat. The structure shields the portion between the front seat and the rear seat with the board and prevents cold air on the front seat side from flowing into the rear seat side.

The inventors found that, under a low-temperature environment, for example, when an air conditioner is used to air condition a limited area, cold air flows into the heated area. In particular, when cold air that has accumulated in the space behind the front seat (the rear seat side, for example) flows into the front seat side through the space under the front seat, the passenger of the front seat feels his/her feet becoming cold; accordingly, comfort inside the vehicle cabin is diminished. On the other hand, when the flow rate of the warm air to the feet is increased in order to avoid the feet from getting cold, another problem of increase in the heating load occurs. Accordingly, a structure is in need that prevents cold air from flowing from the space behind the front seat to the feet of the passenger of the front seat.

However, the disclosure of Japanese Unexamined Utility Model Publication No. H05-72522 does not provide any board under the front seat and no measure is implemented to prevent inflow of cold air from passing through the space under the front seat. In other words, the disclosure of Japanese Unexamined Utility Model Publication No. H05-72522 does not recognize the problem of cold air in the space behind the front seat flowing to the feet of the passenger of the front seat and does not conceive any solution to the problem.

In view of the above, it would be desirable to provide a vehicular cold-air shielding structure that prevents cold air from flowing from the space behind the seat to the feet of the passenger of the seat.

### SUMMARY

In one aspect, the present disclosure describes a vehicular cold-air shielding structure including a seat that is disposed on a floor of a vehicle, the seat being slidable in a front-rear direction of the vehicle, and a first shielding member disposed under the seat, the first shielding member being provided so as to extend in a width direction of the vehicle, in which the first shielding member has a flexibility allowing the first shielding member to follow a sliding movement of the seat.

Accordingly, since the first shielding member that is disposed under the seat and that extends in the width direction of the vehicle is provided, the space under the seat is shielded against longitudinal air flow and cold air can be prevented from flowing from the space behind the seat to the feet of the passenger of the seat. Furthermore, since the first shielding member has a flexibility allowing the first shielding member to follow the sliding movement of the seat, even when the seat is slid in the front-rear direction, the first shielding member follows the seat or the floor; accordingly, the space under the seat can be shielded in a reliable manner.

Furthermore, an upper portion of the first shielding member is preferably connected to the seat.

With such a configuration, since the upper portion of the first shielding member is connected to the seat, the first shielding member can follow the seat sliding in the front-rear direction in a reliable manner.

Furthermore, the upper portion of the first shielding member is preferably connected to the seat and a lower portion of the first shielding member is preferably connected to the floor.

With such a configuration, since the upper portion of the first shielding member is connected to the seat and the lower portion of the first shielding member is connected to the floor, the first shielding member can follow the seat sliding in the front-rear direction in a reliable manner and, further, the first shielding member can prevent a gap from being formed between the lower portion of the shielding member and the floor.

Furthermore, the first shielding member preferably includes a connection member that extends in the width direction of the vehicle and that is connected to the seat, and a shielding skirt that hangs from the connection member and that is provided with an extra length under the seat.

With such a configuration, even when the seat is slid in the front-rear direction, the space under the seat can be shielded in a reliable manner with the shielding skirt performing a following action while being slacked or stretched.

Furthermore, the first shielding member preferably includes a rotating shaft that is provided so as to extend in the width direction of the vehicle and that is coupled to the floor in a rotatable manner about a horizontal axis, and the shielding skirt, the lower portion of which is wound around the rotating shaft and an upper portion of which is connected to the seat. The shielding skirt is preferably capable of being wound around and drawn out from the rotating shaft.

With such a configuration, even when the seat is slid in the front-rear direction, the space under the seat can be shielded in a reliable manner with the shielding skirt performing a following action while the shielding skirt is wound around or drawn out from the rotating shaft.

Furthermore, the first shielding member preferably includes a connection bracket that is provided so as to extend in the width direction of the vehicle and that is connected to one of the floor and the seat, and bristles, base ends of which are fixed to the connection bracket and distal ends of which are in contact with the other of the floor and the seat.

With such a configuration, even when the seat is slid in the front-rear direction, the space under the seat can be shielded in a reliable manner with the bristles performing a following action while standing erect or being tilted.

Furthermore, the bristles are preferably arranged in a staggered manner in plan view.

With such a configuration, the density of the bristles can be increased and the cold air shielding function can be enhanced.

Furthermore, a slide mechanism that slide the seat is preferably provided on both the left and right sides of the bristles, and entanglement prevention members are preferably provided between the bristles and the slide mechanism, the entanglement connection members supporting the bristles at the left and right sides of the bristles and preventing the bristles from being entangled in the slide mechanism.

With such a configuration, the bristles can be prevented from being entangled in the slide mechanism.

Furthermore, second shielding members that are disposed under the left and right sides of the seat are preferably provided so as to extend in the front-rear direction of the vehicle.

With such a configuration, the lower spaces at the left and right sides of the seat can be shielded; accordingly, cold air can be further prevented from flowing from the space behind the seat to the passenger side of the seat.

### BRIEF DESCRIPTION OF THE DRAWINGS

The advantages of the disclosure will become apparent in the following description taken in conjunction with the following drawings.

FIG. 1 is a side view schematically illustrating a vehicle to which a vehicular cold-air shielding structure according to an embodiment of the disclosure is applied.

FIG. 2 is a partially enlarged cross-sectional view illustrating an arrangement of a shielding member according to the embodiment.

FIG. 3A is a perspective view of the shielding member according to the embodiment viewed diagonally from the upper left side, and FIG. 3B is a cross-sectional view taken along line IIIB-IIIB of FIG. 3A.

FIG. 4 is a partially enlarged cross-sectional view illustrating an arrangement of a shielding member according to a first modification.

FIG. 5A is a perspective view of the shielding member according to the first modification viewed diagonally from the upper left side, and FIG. 5B is a cross-sectional view taken along line VB-VB of FIG. 5A.

FIG. 6 is a partially enlarged cross-sectional view illustrating an arrangement of a shielding member according to a second modification.

FIG. 7 is a partially enlarged cross-sectional view illustrating an arrangement of a shielding member according to a third modification.

FIG. 8A is a perspective view of the shielding member according to the third modification viewed diagonally from the upper left side, and FIG. 8B is a partially enlarged plan view of FIG. 8A.

FIG. 9 is a perspective view of a front seat provided with shielding members according to a fourth modification.

FIG. 10A is a side view schematically illustrating a vehicle to which a vehicular cold-air shielding structure according to an example of the present disclosure is applied, and FIG. 10B is a table illustrating results of measurements carried out on the example and a comparative example.

### DETAILED DESCRIPTION

### Embodiment

An embodiment of the present disclosure will be described next in detail while referring to the drawings as required. Note that “front-rear” and “up-down” indicated by arrows in each of the drawings depict the front-rear direction and the up-down direction, respectively, of a vehicle, and “left-right” depicts the left-right direction (the width direction of a vehicle) when seen from a driver seat. Note that the embodiment will be described with an example in which the vehicular cold-air shielding structure of the present disclosure is applied to a driver seat of a vehicle with two rows of seats.

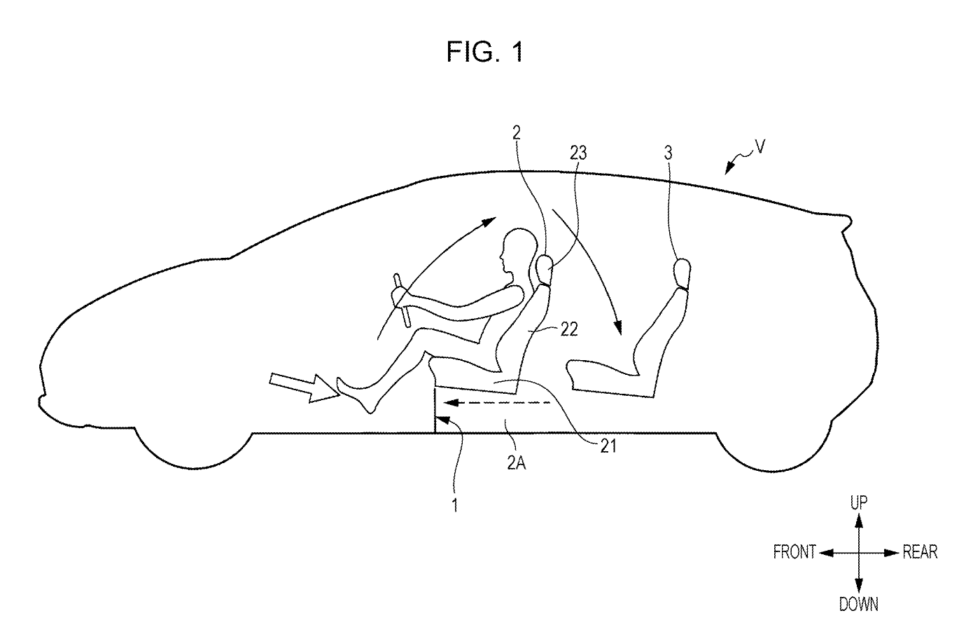

As illustrated in FIG. 1, a vehicle V to which the vehicular cold-air shielding structure of the present disclosure is applied includes a front seat 2 and a rear seat 3 that are aligned in the front-rear direction and a shielding member 1 that is disposed under the front seat 2.

Note that under a low-temperature environment, as illustrated by the broken line arrow in FIG. 1, cold air that has occurred on the rear seat 3 side passing through a space 2A under the front seat 2 and flowing to the feet of a passenger of the front seat 2 becomes a cause of coldness in the feet felt by the passenger. Accordingly, as will be described in detail later, in the embodiment, the shielding member 1 is disposed in the space 2A under the front seat 2 so that the inflow of cold air from the rear seat 3 to the feet of the passenger of the front seat 2 is prevented.

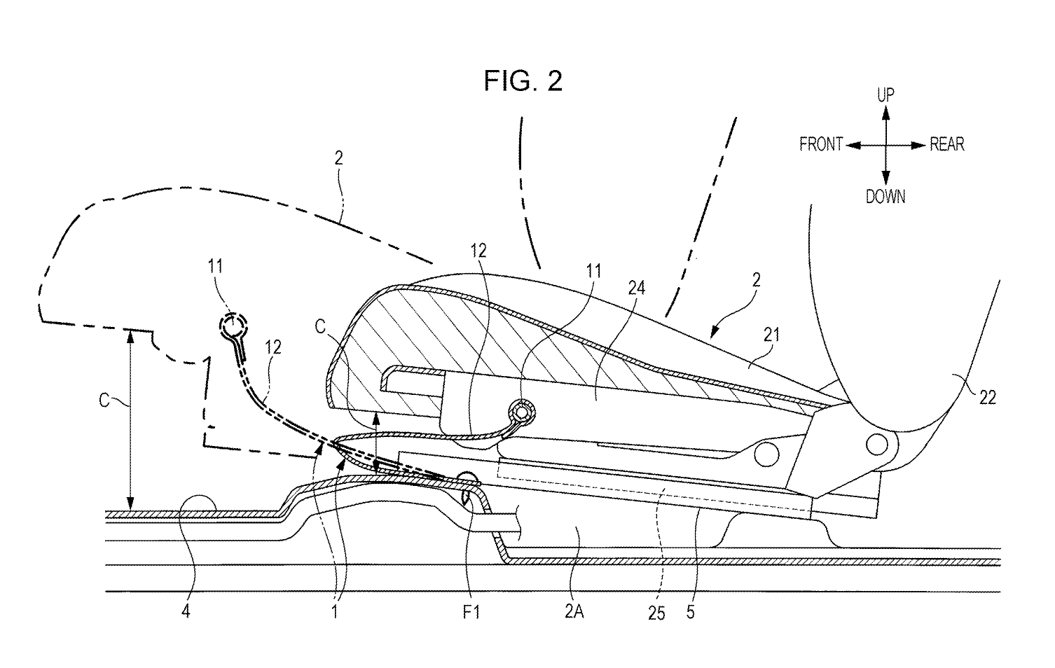

The front seat 2 includes a seat cushion 21, a seatback 22 that stands up at a rear portion of the seat cushion 21, and a headrest 23 that is supported by the upper portion of the seatback 22. As illustrated in FIG. 2, the seat cushion 21 is disposed so as to be slidable with respect to a floor 4 in the front-rear direction of the vehicle through slide rails 5. The seat cushion 21 can be displaced in the up-down direction of the vehicle as well with, for example, a link mechanism (not shown). The seat cushion 21 includes a pair of support frames 24 that are set apart from each other in the left-right direction and that extend in the front-rear direction and sliding portions 25 that are connected to the lower portions of the support frames 24 and that are slidably fitted to the slide rails 5.

The embodiment illustrates a case in which the seat cushion 21 is at its lowest when in the rearmost position and is at its highest when in the front-most position (see the two-dot chain line in FIG. 2). The floor 4 has an uneven shape. Accordingly, a gap dimension C between the front seat 2 and the floor 4 changes depending on the seat position.

The shielding member 1 serving as a first shielding member is disposed in the space 2A under the front seat 2 and is provided so as to extend in the width direction of the vehicle. The shielding member 1 blocks longitudinal path in the space 2A under the front seat 2. The shielding member 1 prevents cold air on the rear seat 3 side from coming in contact with the feet of the passenger of the front seat 2. The shielding member 1 is disposed on the rear side (inner side) with respect to the front end portion of the seat cushion 21.

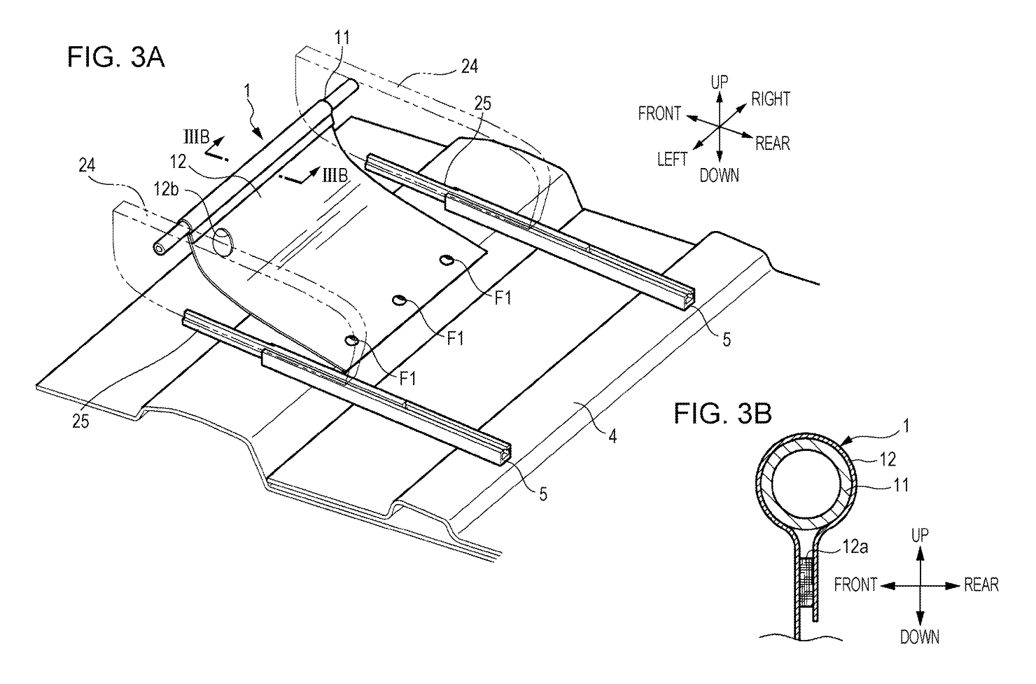

As illustrated in FIG. 3A, the shielding member 1 includes a connection member 11 bridged across the left and right support frames 24 and a shielding skirt 12 hanging from the connection member 11.

The connection member 11 is a cylindrical metal member that connects the front seat 2 and the shielding skirt 12 to each other. The connection member 11 is provided so as to extend in the width direction of the vehicle. The two left and right end portions of the connection member 11 are each fixed to the corresponding support frames 24 with a screw or the like.

The shielding skirt 12 is formed of a material that has flexibility and restorability such as, for example, a natural polypropylene resin and is formed in a sheet shape. The upper portion of the shielding skirt 12 is wound around the outer peripheral surface of the connection member 11 and is hanged from both the front and rear sides of the connection member 11. The hanged front and rear portions are superposed in the front-rear direction and are fixed to each other with a hook and loop fastener 12a (see FIG. 3B). The lower portion of the shielding skirt 12 is connected to the floor 4 with fasteners F1 such as pins. A round through hole 12b for passing a harness (not shown) therethrough is open at an appropriate spot in the shielding skirt 12.

Note that the lower portion of the shielding skirt 12 may not be connected to the floor 4. With such a configuration, a plurality of slits that are spaced apart from one another in the left-right direction may be formed in the lower portion of the shielding skirt 12, alternatively, a foamed material that is softer than the shielding skirt 12 may be provided. By forming the slits or by providing the foamed material, the following performance of the shielding skirt 12 with respect to the floor 4 can be improved.

As illustrated in FIG. 2, the shielding skirt 12 is provided with an extra length in the space 2A under the front seat 2. The shielding skirt 12 is most slack when the seat cushion 21 is in the rearmost and lowest position. The shielding skirt 12 is most stretched when the seat cushion 21 is in the front-most and highest position (see the two-dot chain line in FIG. 2). With such a configuration, even when the seat cushion 21 is slid in the front-rear direction and is displaced in the up-down direction changing the gap dimension C between the seat cushion 21 and the floor 4, the space 2A under the front seat 2 can be shielded in a reliable manner with the shielding skirt 12 performing a following action while being slacked or stretched.

The vehicle V to which the vehicular cold-air shielding structure according to the embodiment is applied is basically configured in the above manner, and the effects thereof will be described next.

According to the embodiment, since a shielding member 1 that is disposed under the front seat 2 and that extends in the width direction of the vehicle is provided, the space 2A under the front seat 2 can be shielded against longitudinal flow of air so that cold air can be prevented from flowing from the rear seat 3 side to the feet of the passenger of the front seat 2. Accordingly, since the feet of the passenger can be suppressed from getting cold, comfort inside the vehicle cabin can be improved and the heating load can be reduced by reducing the flow rate of the warm air hitting the feet. In particular, the embodiment has technical significance in that, when a passenger is only sitting on the front seat 2, inflow of cold air from the rear seat 3 side can be prevented allowing the front seat 2 side to be locally heated and, consequently, reducing energy for heating.

Furthermore, according to the embodiment, the shielding skirt 12 is formed of a flexible material and is provided with an extra length; accordingly, when the seat cushion 21 is slid in the front-rear direction and is displaced in the up-down direction, the shielding skirt 12 performs a following action while being is slacked or stretched. Accordingly, even if the gap dimension C between the seat cushion 21 and the floor 4 changes, the space 2A under the front seat 2 can be reliably shielded.

Furthermore, according to the embodiment, the upper portion of the shielding member 1 is connected to the front seat 2; accordingly, the shielding member 1 can follow the front-rear sliding and the up-down displacement of the front seat 2 in a reliable manner.

Furthermore, according to the embodiment, the lower portion of the shielding member 1 is connected to the floor 4; accordingly, a gap can be prevented from being formed between the lower portion of the shielding member 1 and the floor 4.

Furthermore, according to the embodiment, the upper portion of the shielding skirt 12 is fixed to the connection member 11 with a hook and loop fastener 12a; accordingly, the shielding skirt 12 can be attached to the connection member 11 in a simple and swift manner.

Furthermore, according to the embodiment, the shielding member 1 is disposed on the rear side (inner side) with respect to the front end portion of the seat cushion 21; accordingly, the shielding member 1 is less noticeable and the design can be improved.

### First Modification

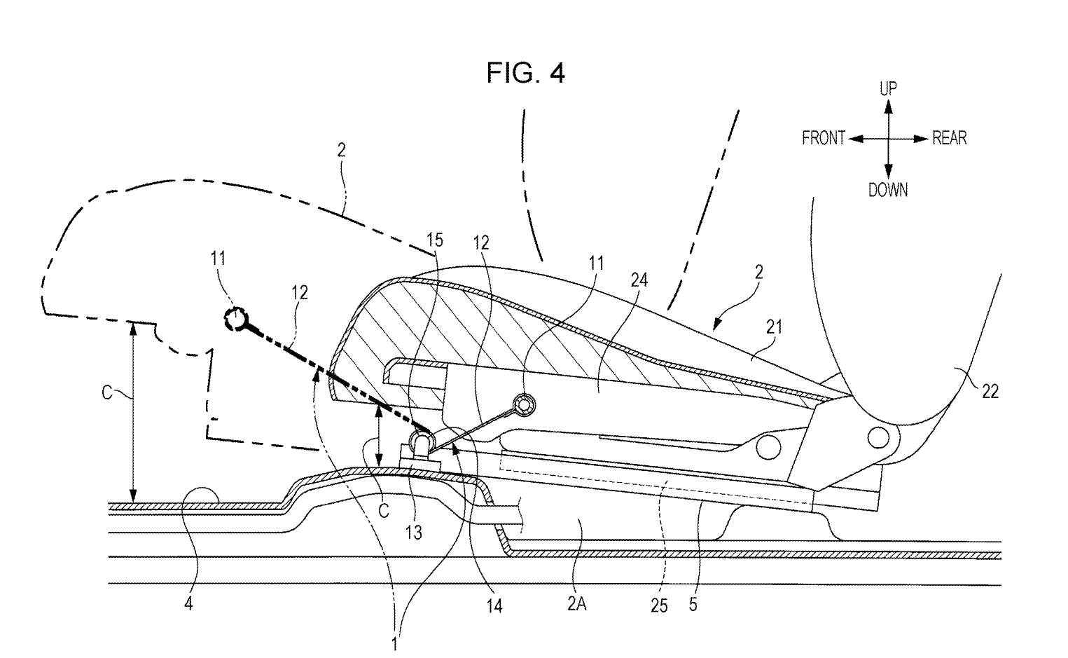

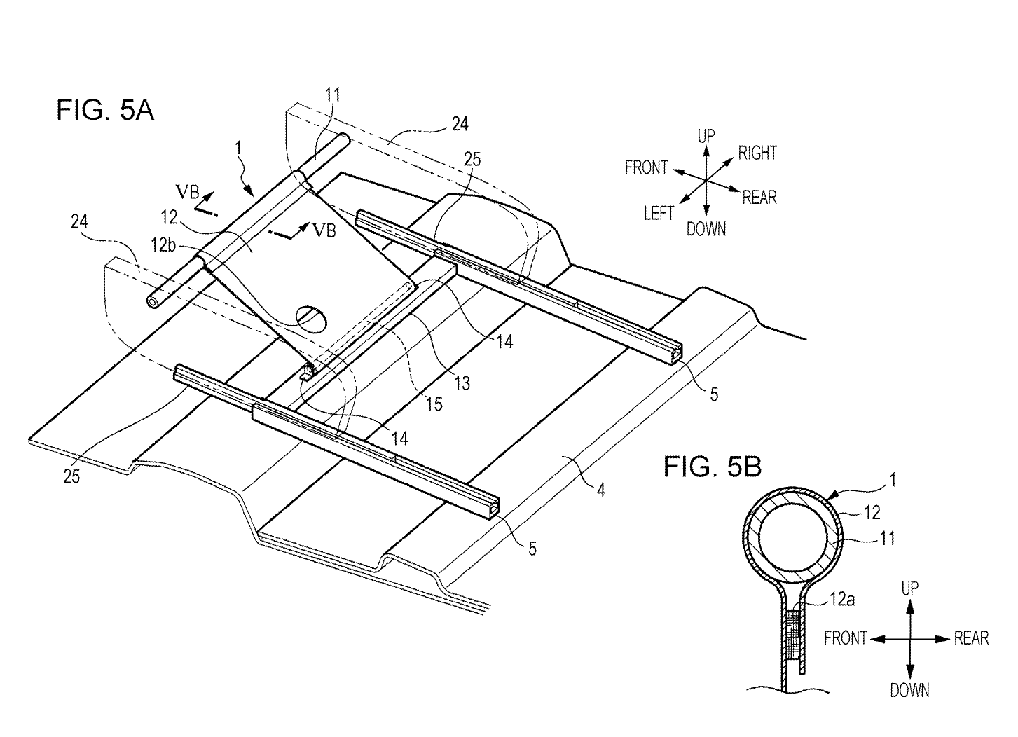

Referring to FIGS. 4, 5A, and 5B, a vehicular cold-air shielding structure according to a first modification of the present disclosure will be described next. The present modification is different from the embodiment in that the shielding member 1 is a roll curtain type shielding member. Note that in the description, points that are different from the embodiment will be described in detail, like components to those of the embodiment are denoted with like reference numerals, and repetition of the same description will be avoided.

As illustrated in FIG. 5A, the shielding member 1 of the present modification includes the connection member 11, a connection bracket 13, a pair of bearings 14, a rotating shaft 15, and the shielding skirt 12.

As illustrated in FIGS. 4 and 5A, the connection member 11 is a cylindrical metal member that connects the front seat 2 and the shielding skirt 12 to each other. The connection member 11 is provided so as to extend in the width direction of the vehicle. The two left and right end portions of the connection member 11 are each fixed to the corresponding support frames 24 with a screw or the like.

As illustrated in FIG. 5A, the connection bracket 13 is a rectangular plate shaped metal member that connects the left and right slide rails 5 to each other. The connection bracket 13 is provided so as to extend in the width direction of the vehicle. The two left and right end portions of the connection bracket 13 are fixed to the lateral sides of the left and right slide rails 5, respectively, with a screw or the like.

The pair of bearings 14 are each a substantially L-shaped metal member that are spaced apart from each other. The bearings 14 are fixed to the upper surface of the connection bracket 13 with a screw or the like.

The rotating shaft 15 is a columnar metal member that is provided so as to extend in the width direction of the vehicle. The rotating shaft 15 is attached to the left and right bearings 14 in a rotatable manner about a horizontal axis.

The shielding skirt 12 is formed of a material that has flexibility and restorability such as, for example, a natural polypropylene resin and is formed in a sheet shape. The upper portion of the shielding skirt 12 is wound around the outer peripheral surface of the connection member 11 and is hanged from both the front and rear sides of the connection member 11. The hanged front and rear portions are superposed in the front-rear direction and are fixed to each other with a hook and loop fastener 12a (see FIG. 5B). The lower portion of the shielding skirt 12 is wound around the outer peripheral surface of the rotating shaft 15. The shielding skirt 12 can be wound around and drawn out from the rotating shaft 15. Although not shown, biasing components that rotates the rotating shaft 15 in the winding up direction are provided at appropriate positions. With such a configuration, as illustrated in FIG. 4, even when the seat cushion 21 is slid in the front-rear direction and is displaced in the up-down direction changing the gap dimension C between the seat cushion 21 and the floor 4, the space 2A under the front seat 2 can be shielded in a reliable manner with the shielding skirt 12 performing a following action while being wound up or drawn out.

### Second Modification

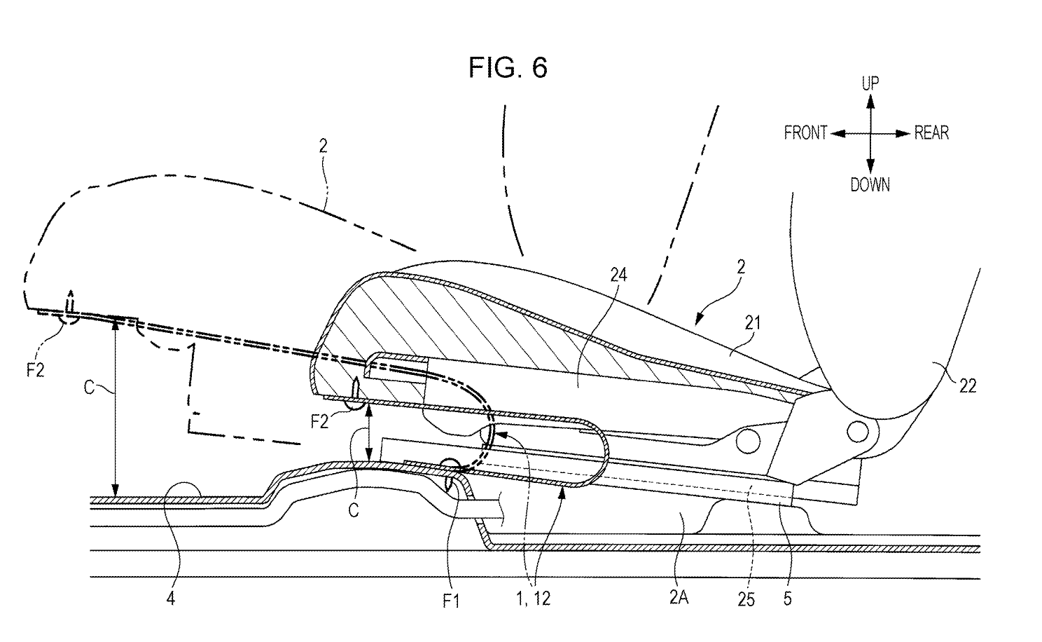

Referring to FIG. 6, a vehicular cold-air shielding structure according to a second modification of the present disclosure will be described next. The present modification is different from the embodiment in that the connection member 11 is omitted and that the shielding member 1 is constituted only by the shielding skirt 12. Note that in the description, points that are different from the embodiment are described in detail, like components to those of the embodiment are denoted with like reference numerals, and repetition of the same description is avoided.

The shielding skirt 12 is formed of a material that has flexibility and restorability such as, for example, a natural polypropylene resin and is formed in a sheet shape. The upper portion of the shielding skirt 12 is connected to the seat cushion 21 with fasteners F2 such as pins. The lower portion of the shielding skirt 12 is connected to the floor 4 with the fasteners F1 such as pins. The upper portion of the shielding skirt 12 is connected in front of the portion where the lower portion is connected. The shielding skirt 12 is disposed in a bent manner such that the shielding skirt 12 is a convexity protruding towards the vehicle rear direction and has a substantially hook-like shape in side view.

The shielding skirt 12 is provided with an extra length in the space 2A under the front seat 2. The shielding skirt 12 is most slack when the seat cushion 21 is in the rearmost and lowest position. The shielding skirt 12 is most stretched when the seat cushion 21 is in the front-most and highest position (see the two-dot chain line in FIG. 6). With such a configuration, even when the seat cushion 21 is slid in the front-rear direction and is displaced in the up-down direction changing the gap dimension C between the seat cushion 21 and the floor 4, the space 2A under the front seat 2 can be shielded in a reliable manner with the shielding skirt 12 performing a following action while being slacked or stretched.

### Third Modification

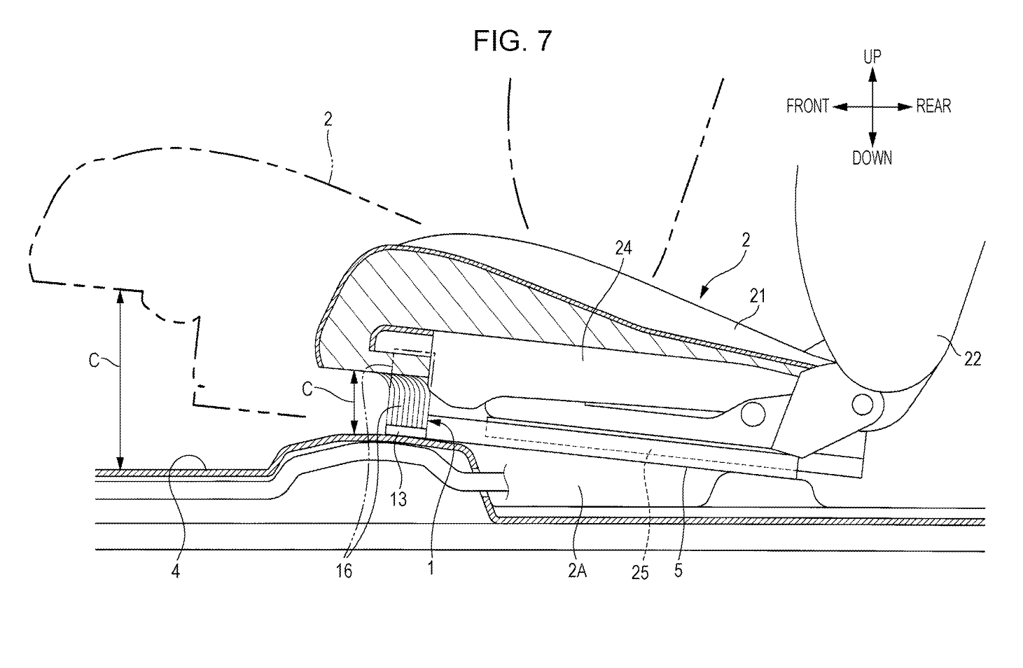

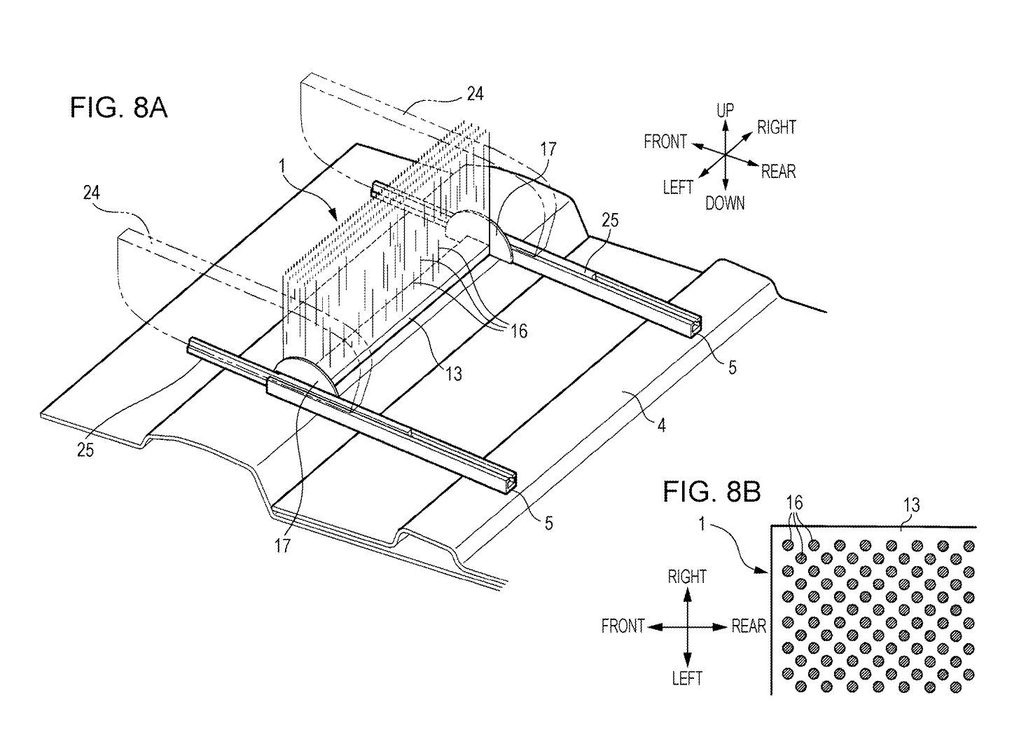

Referring to FIGS. 7, 8A, and 8B, a vehicular cold-air shielding structure according to a third modification of the present disclosure will be described next. The present modification is different from the embodiment in that the shielding member 1 is a brush type shielding member. Note that in the description, points that are different from the embodiment will be described in detail, like components to those of the embodiment are denoted with like reference numerals, and repetition of the same description will be avoided.

As illustrated in FIG. 8A, the shielding member 1 according to the present modification includes a connection bracket 13, bristles 16, and entanglement prevention members 17.

The connection bracket 13 is a rectangular plate shaped resin member that holds the base ends of the bristles 16 and that connects the left and right slide rails 5 to each other. The connection bracket 13 is provided so as to extend in the width direction of the vehicle. The two left and right end portions of the connection bracket 13 are fixed to the lateral sides of the left and right slide rails 5, respectively.

The bristles 16 are formed of, for example, a material having flexibility and restorability such as a resin and each have an elongated columnar shape. A plurality of bristles 16 are implanted in the upper surface of the connection bracket 13. The base ends (the lower portions) of the bristles 16 are fixed to the connection bracket 13. The distal ends (the upper portions) of the bristles 16 are free ends and are in contact with the underside of the seat cushion 21 (see FIG. 7). Note that the connection bracket 13 may be fixed to the front seat 2 and the distal ends (the lower portions) of the bristles 16 may be in contact with the floor 4.

A slide mechanism including the slide rails 5 and the sliding portions 25 is provided at both the left and right sides of the bristles 16. As illustrated in FIG. 7, the bristles 16 stand erect when the seat cushion 21 is in the front-most and highest position (see the two-dot chain line), and in other cases (for example, when the seat cushion 21 is at its rearmost and lowest position), the bristles 16 are tilted. With such a configuration, even when the seat cushion 21 is slid in the front-rear direction and is displaced in the up-down direction changing the gap dimension C between the seat cushion 21 and the floor 4, the space 2A under the front seat 2 can be shielded in a reliable manner by the bristles performing a following action while standing erect or being tilted. As illustrated in FIG. 8B, the bristles 16 are arranged in a staggered manner in plan view. With such a configuration, the density of the bristles 16 can be increased and the cold air shielding function can be enhanced. Note that the material, the thickness, and the like of the bristles 16 may be changed as appropriate to adjust the stiffness of the bristles 16.

As illustrated in FIG. 8A, the entanglement prevention members 17 are semicircular resin members that are provided between the bristles 16 and the slide mechanism. The entanglement prevention members 17 support the bristles 16 at the left and right sides of the bristles 16 and prevent the bristles 16 from becoming entangled in the engagement portion of the slide rails 5 with the sliding portions 25. The entanglement prevention members 17 are formed in an integrated manner with the upper, front, and rear surfaces of both the left and right end portions of the connection bracket 13. The entanglement prevention members 17 are provided so as to extend in directions (in the front-rear direction and the up-down direction) that traverse the connection bracket 13. Note that, in the present modification, although the entanglement prevention members 17 are formed in an integrated manner together with the connection bracket 13, the entanglement prevention members 17 may be formed as bodies separate from the connection bracket 13 and may be fixed to the connection bracket 13.

### Fourth Modification

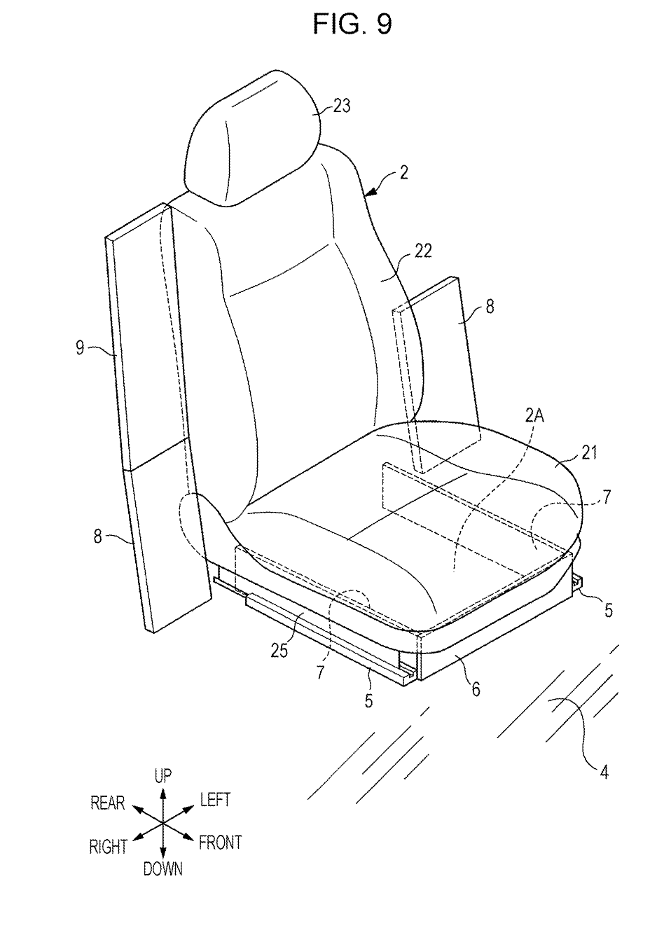

Referring to FIG. 9, a vehicular cold-air shielding structure according to a fourth modification of the present disclosure will be described next. The present modification is different from the embodiment in that a plurality of shielding members are provided. Note that in the description, points that are different from the embodiment will be described in detail, like components to those of the embodiment are denoted with like reference numerals, and repetition of the same description will be avoided.

As illustrated in FIG. 9, the vehicle V to which a vehicular cold-air shielding structure of the present modification is applied includes a first shielding member 6 that is disposed on the front side of the space 2A under the front seat 2, a pair of second shielding members 7 that are disposed on the left and right sides of the space 2A under the front seat 2, a pair of third shielding members 8 that are disposed at the lower left and right sides of the front seat 2, and a fourth shielding member 9 that is disposed at the upper right side of the front seat 2.

The first shielding member 6 is disposed on the front side of the space 2A under the front seat 2 and is provided so as to extend in the width direction of the vehicle. The first shielding member 6 shields the front side of the space 2A under the front seat 2. The first shielding member 6 prevents cold air on the rear seat 3 side (see FIG. 1) from coming in contact with the feet of the passenger of the front seat 2. The first shielding member 6 is disposed on the rear side (inner side) with respect to the front end portion of the seat cushion 21. Accordingly, the first shielding member 6 is less noticeable and the design can be improved. Note that the first shielding member 6 that is used is selected as appropriate from either one of the shielding members 1 of the embodiment and the first to third modifications.

The pair of second shielding members 7 are disposed so as to be spaced apart from each other in the left-right direction and in the space 2A under the front seat 2 and are provided so as to extend in the front-rear direction of the vehicle. The second shielding members 7 shield the left and right sides of the space 2A under the front seat 2. The second shielding members 7 prevent cold air on the rear seat 3 side from coming in contact with the legs of the passenger of the front seat 2. The second shielding members 7 are disposed on the inner side with respect to the side end portions of the seat cushion 21. Accordingly, the second shielding members 7 are less noticeable and the design can be improved. The second shielding members 7 are provided so as to extend towards the rear of the vehicle from the rear portion of the first shielding member 6. Note that a configuration similar to the configuration of either one of the shielding members 1 of the embodiment and the first to third modifications is applied to the second shielding members 7. Accordingly, even when the seat cushion 21 is slid in the front-rear direction and is displaced in the up-down direction changing the gap dimension C between the seat cushion 21 and the floor 4, the space 2A under the front seat 2 can be shielded in a reliable manner with the second shielding members 7 performing a following action.

The pair of third shielding members 8 are provided at the lower left and right sides of the front seat 2 and are provided so as to extend in the up-down direction of the vehicle. The third shielding members 8 shield longitudinal air flow at the lower left and right sides of the front seat 2. The third shielding members 8 prevent cold air on the rear seat 3 side from coming in contact with the waist portion and the thigh portions of the passenger of the front seat 2. The third shielding members 8 are positioned at the outer side of the rear portion of the second shielding members 7.

The fourth shielding member 9 is disposed on the vehicle exterior side of the front seat 2 and is provided so as to extend in the up-down direction (along the seatback 22) of the vehicle. The fourth shielding member 9 shields longitudinal air flow at the vehicle exterior side (the door side) of the front seat 2. The fourth shielding member 9 prevents cold air on the rear seat 3 side from coming in contact with the waist portion and the thigh portions of the passenger of the front seat 2. The fourth shielding member 9 extends from a portion near the lower portion of the seatback 22 to the upper portion of the seatback 22. The lower portion of the fourth shielding member 9 is connected to the upper portion of the third shielding member 8 that is disposed on the vehicle exterior side.

The present modification can prevent cold air from flowing from the rear seat 3 side to the front seat 2 side in a wider area compared to the area prevented by the embodiment. Accordingly, comfort inside the vehicle cabin can be further improved and the heating load can be further reduced by further reducing the flow rate of the warm air.

While the embodiment and the modifications of the present disclosure have been described above in detail with reference to the drawings, the present disclosure is not limited to the above and modifications may be made as appropriate within the scope of the disclosure.

In the embodiment and the modifications, the present disclosure is applied to the driver seat; however, the present disclosure may be applied to the front passenger seat. Furthermore, in the embodiment and the modifications, the present disclosure is applied to a vehicle with two rows of seats; however, the present disclosure may be applied to, for example, a vehicle with three rows of seats or a two-seater vehicle.

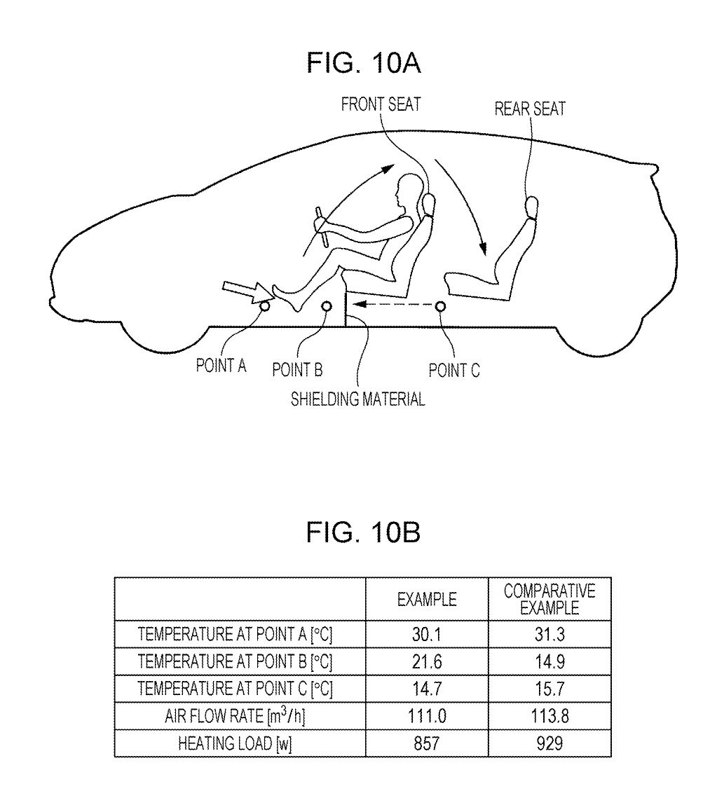

Referring next to FIG. 10, the vehicular cold-air shielding structure of the present disclosure will be described in further detail with an example and a comparative example. Among the referred drawings, FIG. 10A is a side view schematically illustrating a vehicle to which a vehicular cold-air shielding structure according to the example of the present disclosure was applied. FIG. 10B is a table illustrating the results of measurements carried out on the example and the comparative example.

In the vehicles according to the example and the comparative example, temperatures at point A to point C illustrated in FIG. 10A, air flow rates from an outlet of an air conditioning device, and heating loads of the air conditioning device were each measured. Point A is a portion near the feet outlet of the air conditioning device. Point B is at the feet of the passenger and is close to the front seat. Point C is at the lower side of the rear seat.

### Example

As illustrated in FIG. 10A, similar to the embodiment, the example included a shielding member.

### Comparative Example

The comparative example was configured with no shielding member.

Then, the temperatures at the points A to C of the example and the temperatures at the points A to C of the comparative example were measured; the measurement results are shown in the table of FIG. 10B. By comparing the two, it was confirmed that the example was about 1 degree lower than the comparative example at point A and point C. Meanwhile, it was confirmed that at point B, which is a point that is related to the cold feet of the passenger, the example was 6.7 degrees higher than the comparative example.

Furthermore, the measurement results of the air flow rate and the heating load of the example and the measurement results of the air flow rate and the heating load of the comparative example were as illustrated in the table of FIG. 10B. By comparing the two, it was confirmed that the air flow rate and the heating load of the example was lower than those of the comparative example.

Comparison between the example and the comparative example as above verified that, by providing a shielding member, cold air can be prevented from flowing from the rear seat side to the feet of the passenger of the front seat and, further, that the air flow rate and the heating load can be reduced.

We claim:

1. A vehicular cold-air shielding structure, comprising:
a seat disposed on a floor of a vehicle, the seat being slidable in a front-rear direction of the vehicle; and
a first shielding member disposed under the seat, the first shielding member extending in a width direction of the vehicle, wherein
the first shielding member has a flexibility allowing the first shielding member to follow a sliding movement of the seat.

2. The vehicular cold-air shielding structure according to claim 1, wherein
an upper portion of the first shielding member is connected to the seat.

3. The vehicular cold-air shielding structure according to claim 1, wherein
an upper portion of the first shielding member is connected to the seat, and
a lower portion of the first shielding member is connected to the floor.

4. The vehicular cold-air shielding structure according to claim 1, wherein
the first shielding member includes
a connection member extending in the width direction of the vehicle and connected to the seat, and
a shielding skirt hanging from the connection member, wherein
the shielding skirt is provided with an extra length under the seat.

5. The vehicular cold-air shielding structure according to claim 1, wherein
the first shielding member includes
a rotating shaft extending in the width direction of the vehicle, the rotating shaft being coupled to the floor in a rotatable manner about a horizontal axis, and
a shielding skirt, a lower portion of which is wound around the rotating shaft and an upper portion of which is connected to the seat, wherein
the shielding skirt is capable of being wound around and drawn out from the rotating shaft.

6. The vehicular cold-air shielding structure according to claim 1, wherein
the first shielding member includes
a connection bracket extending in the width direction of the vehicle, the connection bracket being connected to one of the floor and the seat, and
bristles, base ends of which are fixed to the connection bracket and distal ends of which are in contact with the other of the floor and the seat.

7. The vehicular cold-air shielding structure according to claim 6, wherein
the bristles are arranged in a staggered manner in plan view.

8. The vehicular cold-air shielding structure according to claim 6, further comprising
slide mechanisms that slide the seat, the slide mechanisms being provided on left and right sides of the bristles, respectively, and
entanglement prevention members each provided between the bristles and corresponding one of the slide mechanisms, the entanglement prevention members supporting left and right sides of the bristles and preventing the bristles from being entangled in the slide mechanisms.

9. The vehicular cold-air shielding structure according to claim 1, further comprising
second shielding members that are disposed under the left and right sides of the seat, respectively, the second shielding members extending in the front-rear direction of the vehicle.

10. A vehicular cold-air shielding structure, comprising:
a seat disposed on a floor of a vehicle, the seat being slidable in a front-rear direction of the vehicle; and
a first shielding member disposed under the seat, the first shielding member extending in a width direction of the vehicle to stop a cold air from flowing through the underneath of the seat, wherein
the first shielding member has a flexibility allowing the first shielding member to follow a sliding movement of the seat.

11. A vehicular cold-air shielding structure, comprising:
a seat disposed on a floor of a vehicle, the seat being slidable in a front-rear direction of the vehicle; and
first shielding means disposed under the seat and extending in a width direction of the vehicle to stop a cold air from flowing through the underneath of the seat, wherein
the first shielding means has a flexibility allowing the first shielding means to follow a sliding movement of the seat in the front-rear direction.

12. The vehicular cold-air shielding structure according to claim 3, wherein
the first shielding member has a sheet shape, and
the first shielding member has a bent portion between the upper portion and the lower portion.

13. The vehicular cold-air shielding structure according to claim 12, wherein
the bent portion protrudes toward the rear of the vehicle.

14. The vehicular cold-air shielding structure according to claim 4, wherein
the shielding skirt is longer than a height of a space between the floor and the seat.

15. The vehicular cold-air shielding structure according to claim 1, wherein
the first shielding member includes
a rotating shaft extending in the width direction of the vehicle, the rotating shaft being coupled to the floor in a rotatable manner about a horizontal axis, and
a shielding skirt, a lower portion of which is attached to the rotating shaft and an upper portion of which is connected to the seat, wherein
the rotating shaft rotates such that shielding skirt is wound around and drawn out from the rotating shaft.
